(19) United States
(12) Patent Application Publication
(10) Pub. No.: US 2008/0065897 A1
(43) Pub. Date: Mar. 13, 2008

(54) Enhanced Security for Display Device

(75) Inventors: Subramanian Jayaram, Austin, TX (US); Samuel Nicklaus D'Alessio, Round Rock, TX (US); Stanley Howard Osgood, Georgetown, TX (US)

Correspondence Address: HAYNES AND BOONE, LLP, 901 Main Street, Suite 3100, Dallas, TX, 75202, US

(73) Assignee: Dell Products L.P., Round Rock, TX (US)

(21) Appl. No.: 11/530,247

(22) Filed: Sep. 8, 2006

(51) Int. Cl. G06F 12/14; G06F 11/00; H04L 9/00; G06F 17/30; G06F 1/26; H04K 1/00; G06F 12/00; G08B 13/00; G06F 13/00; G08B 21/00; G06F 7/04; G08B 29/00; G06F 7/58; G06K 19/00; G11C 7/00; H04L 9/32

(52) U.S. Cl. 713/183; 726/17; 726/35

(57) ABSTRACT

For securing a portable device, a first input is received to determine whether a security feature is enabled. A second input is received from a sensor to determine a presence of a physical lock for securing the portable device. A prompt for a password is output in response to determining an absence of the physical lock. A third input is received to verify the password. Upon verifying the password, the portable device is enabled, otherwise it is disabled. The prompt for the password is bypassed and the portable device is enabled if the physical lock is present.

### BACKGROUND

The present disclosure relates generally to information handling systems, and more particularly to tools and techniques for enhancing security of display systems used for displaying images.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, entertainment, enterprise data storage, or global communications. In addition, IHSs may include a variety of hardware and software components that may be configured to process, store, and communicate information and may include one or more computer systems, data storage systems, and networking systems.

Presently, a variety of display systems may be deployed to display information provided by the IHS, and/or by multimedia entertainment devices such as optical media players/recorders, television sets, cable and/or satellite receivers, and similar others. For example, some IHS systems may use a liquid crystal display (LCD) and/or plasma display panel. The relative size and cost of the display panel may limit the presentation capability of this display system to a smaller room/audience. A larger size may also limit the portability of the display panel based IHS. Hence, projection display systems, especially portable projectors, have gained in acceptance for cost effectively projecting bigger than life images, which are often desired in larger presentation rooms such as classrooms, lecture halls, forum/meeting rooms, and similar others.

Like car stereos and laptop computers, theft of portable projectors has become a common occurrence. Traditional techniques to prevent theft and unauthorized use of valuable portable property such as the portable projector may include securing the projector to a heavy and/or immovable object by a physical Kensington type lock, affixing magnetic and/or radio frequency (RF) type security tags to activate audible alarms when the tag leaves a secured area, closed circuit television monitoring, Internet Protocol (IP) network notification when the portable projector is disconnected from the IP network, and similar others. Many of these techniques, which may be bypassed by hackers/thieves, often result in increased complexity for the user, thereby degrading the user experience in using the portable devices.

### SUMMARY

Applicants recognize an existing need for enhancing security of valuable portable components such as a portable projector included in an IHS; and the need for retaining the portability and mobility features, while enhancing the security, and ease of use features of the portable projector, absent the disadvantages found in the prior techniques discussed above.

The foregoing need is addressed by the teachings of the present disclosure, which relates to improving security and user experience in handling valuable portable devices. According to one embodiment, in a method and system for securing a portable device, a first input is received to determine whether a security feature is enabled. A second input is received from a sensor to determine a presence of a physical lock for securing the portable device. A prompt for a password is output in response to determining an absence of the physical lock. A third input is received to verify the password. Upon verifying the password, the portable device is enabled, otherwise it is disabled. The prompt for the password is bypassed and the portable device is enabled if the physical lock is present.

In one aspect of the disclosure, a security system for securing a portable device includes a security enabler that is configurable to enable the securing of the portable device. A physical lock is operable to provide a secured coupling between the portable device and a secured object. A sensor coupled to the portable device is operable to detect the secured coupling. A password handler included in the portable device is operable to prompt for a password in response to an absence of the secured coupling, receive the password, and verify the password to enable the portable device.

Several advantages are achieved according to the illustrative embodiments presented herein. The embodiments advantageously provide an improved user experience while providing improved security for the portable projector. The improved security features may be configured to be selectively enabled or disabled. The user experience is improved since the user may not have to provide a password as long as the integrity of the physical lock remains unchanged. The user may be prompted for the password only when the physical lock has been detected to be absent or removed. Portable projectors may be advantageously secured to mobile carts that may be moved from one location to another, thus preserving the portability of the portable projector while enhancing the security. In the event the portable projector is stolen or removed from the mobile cart, unauthorized use of the portable projector is substantially reduced by disabling the portable projector when the password is unable to be verified.

### BRIEF DESCRIPTION OF THE DRAWINGS

FIG. 1 illustrates a block diagram of an IHS, according to an embodiment.

FIG. 2 illustrates a block diagram of a portable projector, according to an embodiment.

FIG. 3 is a flow chart illustrating a method for securing a portable device, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements. Similarly, the functionality of various mechanical elements, members, and/or components for forming modules, sub-assemblies and assemblies assembled in accordance with a structure for an apparatus may be implemented using various materials and coupling techniques, depending on the application requirements.

As described earlier, many of the traditional techniques for preventing theft and unauthorized use of valuable portable property such as a portable projector often result in reduced portability, and/or increased complexity for the user, thereby degrading the user experience in using the portable devices. In addition, many of these techniques are often bypassed by hackers/thieves. Therefore, a need exists for retaining the portability and mobility features of a portable projector, while enhancing its security, and ease of use features. According to one embodiment, a first input is received to determine whether a security feature is enabled. A second input is received from a sensor to determine a presence of a physical lock for securing the portable device. A prompt for a password is output in response to determining an absence of the physical lock. A third input is received to verify the password. Upon verifying the password, the portable device is enabled, otherwise it is disabled. The prompt for the password is bypassed and the portable device is enabled if the physical lock is present.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, the IHS may be a personal computer, including notebook computers, personal digital assistants, cellular phones, gaming consoles, a network storage device, or any other suitable device and may vary in size, shape, performance, functionality, and price. The IHS may include random access memory (RAM), one or more processing resources such as central processing unit (CPU) or hardware or software control logic, read only memory (ROM), and/or other types of nonvolatile memory. Additional components of the IHS may include one or more disk drives, one or more network ports for communicating with external devices as well as various I/O devices, such as a keyboard, a mouse, and a video display. The IHS may also include one or more buses operable to receive/transmit communications between the various hardware components.

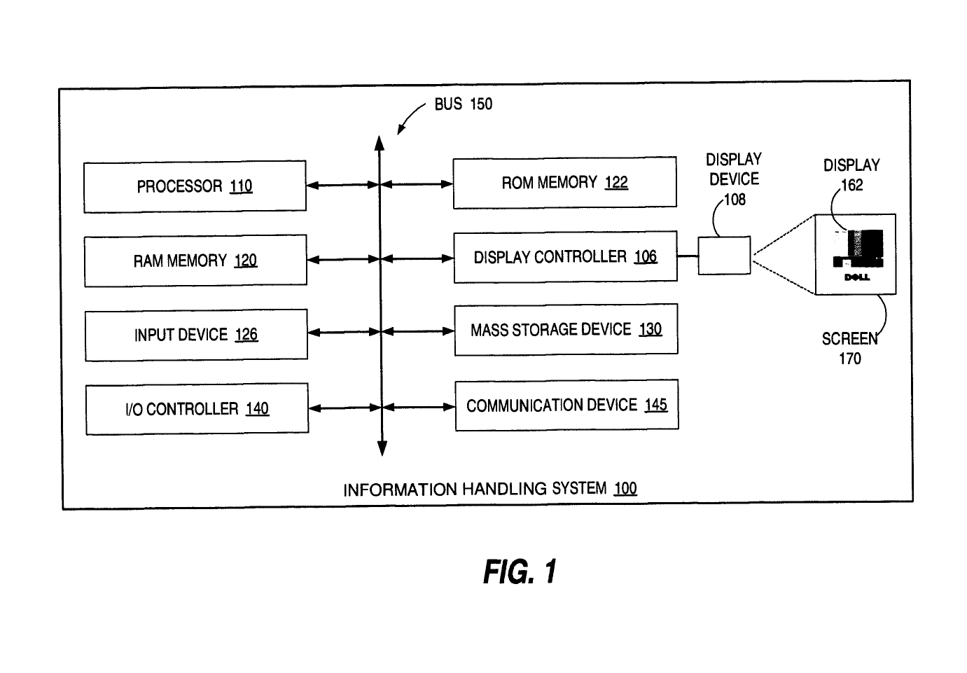

FIG. 1 illustrates a block diagram of an IHS 100, according to an embodiment. The IHS 100 includes a processor 110, which is coupled to a bus 150. The bus 150 serves as a connection between the processor 110 and other components of the IHS 100. An input device 126 is coupled to the processor 110 to provide input to the IHS 100. Examples of input devices may include keyboards, touchscreens, and pointing devices such as mouses, trackballs and trackpads. Software programs, including instructions, and data are stored on a mass storage device 130, which is coupled to processor 110 via the bus 150. Mass storage devices may include such devices as hard disks, optical disks, magneto-optical drives, floppy drives and the like. The IHS system 100 further includes a display controller 106 to generate displays that are displayable on a display device 108, the display controller 106 being coupled to the processor 110 by the bus 150. A system memory 120, which may also be referred to as RAM or main memory, is coupled to the processor 110 to provide the processor with fast storage to facilitate execution of computer programs by the processor 110. In an embodiment, a chassis (not shown) houses some or all of the components of IHS 100. It should be understood that other buses and intermediate circuits can be deployed between the components described above and processor 110 to facilitate interconnection between the components and the processor 110.

The IHS 100 may also include a non-volatile ROM 122 memory, an I/O controller 140 for controlling various other I/O devices. For example, the I/O controller 140 may include a serial, and/or parallel I/O bus controller. It should be understood that the term “information handling system” is intended to encompass any device having a processor that executes instructions from a memory medium.

The IHS 100 is shown to include the mass storage device 130 connected to the processor 110, although some embodiments may not include the mass storage device 130. In a particular embodiment, the IHS 100 may include additional hard disks. The bus 150 may include data, address and control lines. In an exemplary, non-depicted embodiment, not all devices shown may be directly coupled to the bus 150. In one embodiment, the IHS 100 may include multiple instances of the bus 150. The multiple instances of the bus 150 may be in compliance with one or more proprietary standards and/or one or more industry standards such as peripheral component interconnect (PCI), PCI express (PCIe), industry standard architecture (ISA), universal serial bus (USB), system management bus (SMBus), and similar others. A communications device 145, such as a network interface card and/or a radio device, may be connected to the bus 150 to enable wired and/or wireless information exchange between the IHS 100 and other devices (not shown).

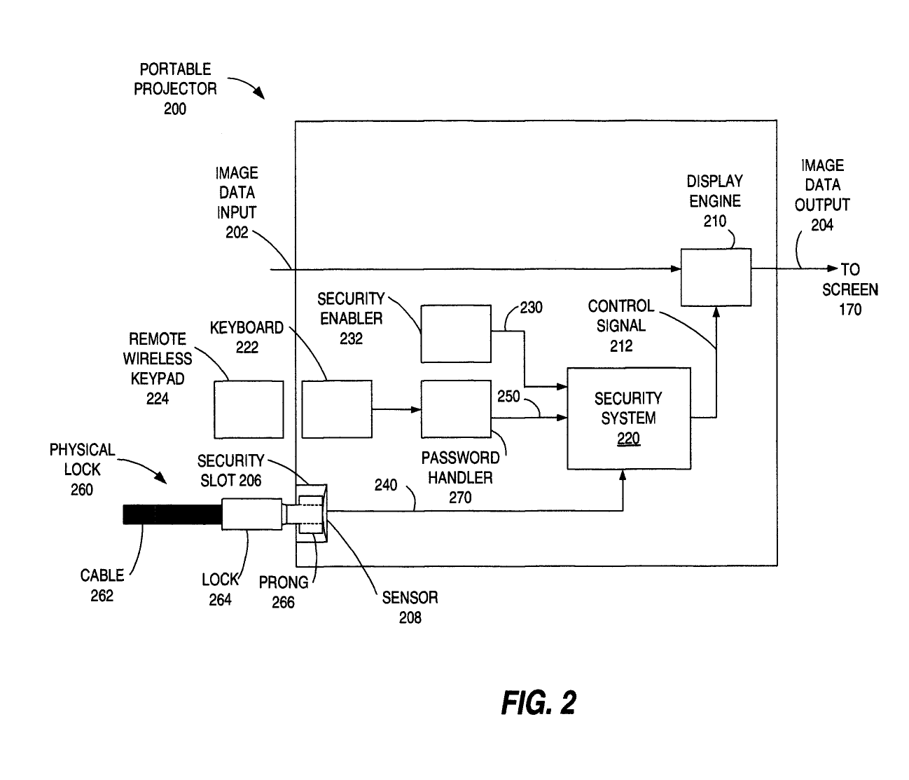

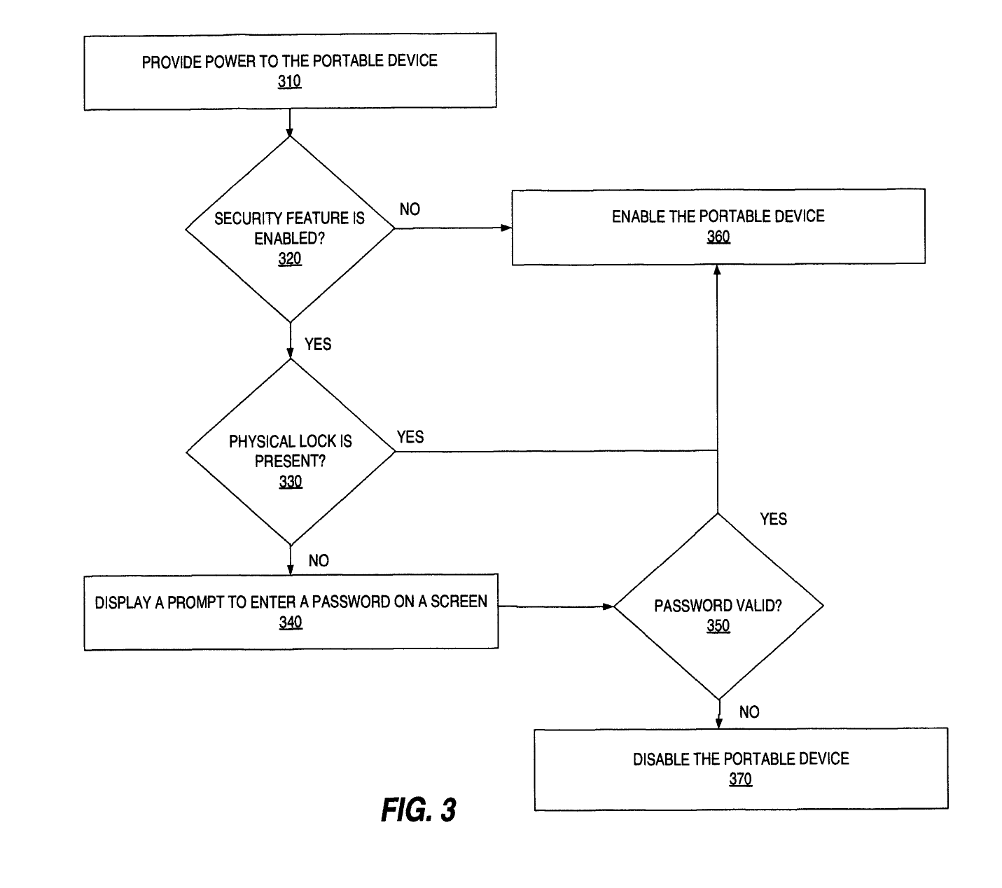

In an embodiment, the display device 108 is a portable device such as a portable projector operable to project one or more displays 162 on a screen 170. In an exemplary, non-depicted embodiment, the display device 108 may be secured to a secure object by using a physical lock. Examples of a secure object may include an office desk or similar other object that may be difficult to move outside a restricted area. The physical lock provides a secured coupling between the portable device and the secured object. Additional detail of the operation of the portable projector is described with reference to FIGS. 2 and 3.

The processor 110 is operable to execute the instructions and/or operations of the IHS 100. The memory medium, e.g., RAM 120, preferably stores instructions (also known as a “software program”) for implementing various embodiments of a method in accordance with the present disclosure. An operating system (OS) (not shown) of the IHS 100 is a type of software program that controls execution of other software programs, referred to as application software programs. An example of an application program may include a program to display an image onto the screen 170. In various embodiments the instructions and/or software programs may be implemented in various ways, including procedure-based techniques, component-based techniques, and/or object-oriented techniques, among others. Specific examples include assembler, C, XML, C++ objects, Java and Microsoft's .NET technology.

FIG. 2 illustrates a block diagram of a portable projector 200, according to an embodiment. In a particular embodiment, the portable projector 200 is substantially similar to the display device 108 described with reference to FIG. 1. In the depicted embodiment, the portable projector 200 includes a display engine 210 that is operable to receive an image data input 202 in the form of an electrical signal and provide an image data output 204 in the form of an optical signal. In an embodiment, the image data input 202 may be received from an image source such the display controller 106, an entertainment device such as a DVD player, a gaming device, a cable/satellite receiver, and similar others. In an embodiment, the image data output 204 is projectable on the screen 170 as one or more displays 160. In an embodiment, the display engine 210 may be implemented using logic circuits such as a field programmable gate array (FPGA), and/or an application specific integrated circuit (ASIC). The display engine 210 may also include an operating system for performing various I/O and image processing functions.

In the depicted embodiment, the display engine 210 is configurable to be enabled or disabled responsive to a control signal 212 received from a security system 220 that provides improved security. The security system 220 is also configurable to be enabled or disabled. When the security system 220 is disabled, the control signal 212 is also disabled and the display engine 210 is configured to generate the image data output 204 in response to the image data input 202. When the security system 220 is enabled, the control signal 212 may determine whether the display engine 210 is enabled or disabled.

In an embodiment, the portable projector 200 may be operable as a standalone device that provides the image data output 204 with or without receiving the image data input 202. For example, during initial setup or configuration of the portable projector 200, the display engine 210 may automatically provide the image data output 204 as an initial default display to configure the portable projector 200 even though the portable projector 200 is not coupled to receive the image data input 202.

In the depicted embodiment, the security system 220 is operable to receive a first input 230 indicative of a enable or disable status of the security system 220 from a security enabler 232, a second input 240 indicative of a presence or absence of a physical lock 260 for securing the portable projector 200 from a sensor 208, and a third input 250 indicative of a password verification status received from a password handler 270. The security system 220 is operable to provide the control signal 212 in response to receiving the first, second, and third inputs 230, 240, and 250. In an embodiment, the enable or disable status of the security system 220 is configured and stored in the security enabler 232, which may be stored in non-volatile memory (not shown) of the portable projector 200.

The physical lock 260 includes a plastic coated metal cable 262 having a lock 264 (e.g., may be a combination or key lock) attached to one end, with the other end formed into a loop (not shown). The lock end of the cable 262 is threaded through the loop and through a secure object (not shown) such as an office table or similar other object that may be difficult to move outside a restricted area. In a particular embodiment, the secure object is a movable cart that may be moved from one location to another within a secured building or facility. The lock end of the cable 262 has a prong 266 that may be inserted into a security slot 206 of the portable projector 200 and locked to secure the portable projector 200 to the secure object. The prong 266 may not be removed from the security slot 206 when the lock 264 is in a locked position, whereas the prong 266 may be easily removed from the security slot 206 when the lock 264 is in an unlocked position.

In the depicted embodiment, the portable projector 200 includes the sensor 208, which may be located within the security slot 206. In an embodiment, the sensor 208 is operable to detect a presence or an absence of the physical lock 260 by detecting a presence or absence of the prong 266. The security system 220 receives the second input 240 from the sensor 208, the second input 240 being indicative of a presence or an absence of the physical lock 260. An absence of the physical lock status when power is initially provided to the portable projector 200 is stored in non-volatile memory and may be cleared only when a proper password is provided. This technique advantageously excludes hackers and/or thieves from inserting a fake prong into the security slot 206 to simulate a presence of the physical lock 260.

The password handler 270 is coupled to a keyboard 222 of the portable projector 200. A user (not shown), when prompted, may provide a password input by using the keyboard 222 and/or a remote wireless keypad 224. In a particular embodiment, the password is an N-digit integer number that is stored in a non-volatile memory (not shown) of the portable projector 200 as an encrypted or non-encrypted value. The user may change the password from a default value to a user-defined value. The password handler 270 is operable to verify and/or authenticate a password provided by the user and provide the third input 250 that is indicative of a verified or non-verified status of the password. In the event, the password provided by the user is not valid, and/or is not verifiable, the security system 220 disables the display engine 210 via the control signal 212.

In a particular embodiment, user experience is improved by making the security monitoring features transparent to the user until there is a potential violation of security. Thus, the user may be prompted for the password only when the security system 220 is enabled and the sensor 208 detects an absence of the physical lock 260, indicative of the potential violation of security. When such a potential violation of security is detected, the user is advised of the potential breach in security of the portable projector 200, and prompted to input the password by projecting an advisory display (not shown) on the screen 170.

FIG. 3 is a flow chart illustrating a method for securing a portable device, according to an embodiment. In a particular embodiment, the portable device is substantially the same as the portable projector 200 described with reference to FIG. 2. At step 310, the portable device is powered up. Upon initial power condition and/or after a reset applied to the portable device, various components of the portable device such as buffers and registers are initialized, thereby enabling the portable device to process inputs and outputs. At step 320, a determination is made whether a security feature such as the security system 220 is enabled or disabled. At step 330, if the security feature is enabled, a determination is made whether a physical lock is present or absent. At step 340, a prompt to enter a password is displayed on a screen in response to determining an absence of the physical lock. At step 350, the password is verified to be valid or invalid. At step 360, the portable device is enabled in response to verification of the password. At step 370, the portable device is disabled in response to non-verification of the password. A password may be determined to be non-verifiable after a predefined number of unsuccessful attempts to provide the correct password.

In the event a user forgets or misplaces the password, the user may contact factory service via telephone and/or web to authenticate user identity, provide a serial number of device, and obtain a new password. In an embodiment, an express service code number and/or a serial number of the portable device may be used to algorithmically and automatically generate another password that the portable device is configured to recognize as valid.

Various steps described above may be added, omitted, combined, altered, or performed in different orders. For example, steps 340, and 350 may be bypassed after step 330, in response to determining that the physical lock is present.

Several advantages are achieved according to the illustrative embodiments presented herein. The embodiments advantageously provide an improved user experience while providing improved security for the portable projector. The improved security features may be configured to be selectively enabled or disabled. The user experience is improved since the user may not have to provide a password as long as the integrity of the physical lock remains unchanged. The user may be prompted for the password only when the physical lock has been detected to be absent or removed. Portable projectors may be advantageously secured to mobile carts that may be moved from one location to another, thus preserving the portability of the portable projector while enhancing the security. In the event the portable projector is stolen or removed from the mobile cart, unauthorized use of the portable projector is substantially reduced by disabling the portable projector when the password is unable to be verified.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A method for securing a portable device, the method comprising:
determining whether a security feature is enabled;
determining a presence of a physical lock for securing the portable device;
prompting for a password in response to an absence of the physical lock; and
verifying the password.

2. The method of claim 1 further comprising:
enabling the portable device in response to a verification of the password; and
disabling the portable device in response to a non-verification of the password.

3. The method of claim 1, wherein the non-verification occurs as a result of a mismatch of the password after a predefined number of attempts.

4. The method of claim 1, wherein the portable device is movable from a first location to another location without removing the physical lock.

5. The method of claim 1 further comprising:
enabling the portable device in response to determining that the physical lock is present.

6. The method of claim 1, wherein the prompting for the password and verifying of the password are bypassed when the physical lock is present.

7. The method of claim 1, wherein the physical lock is a Kensington type lock.

8. The method of claim 1, wherein the presence of the physical lock is detected by a sensor, the sensor being activated in response to a prong of the physical lock being inserted into a security slot of the portable device.

9. The method of claim 1, wherein the portable device displays the prompting for the password.

10. The method of claim 1, wherein the prompting for the password includes indicating the absence of the physical lock.

11. A security system for securing a portable device, the security system comprising:
a security enabler, wherein the security enabler is configurable to enable the securing of the portable device;
a physical lock operable to provide a secured coupling between the portable device and a secured object;
a sensor coupled to the portable device is operable to detect the secured coupling; and
a password handler included in the portable device, the password handler operable to prompt for a password in response to an absence of the secured coupling, receive the password, and verify the password to enable the portable device.

12. The system of claim 11, wherein the secured coupling includes a prong of the physical lock that is insertable into a security slot of the portable device.

13. The system of claim 11, wherein the password handler is bypassed when the secured coupling is detected.

14. The system of claim 11, wherein the portable device is disabled in response to a failure to verify the password.

15. The system of claim 11, wherein the portable device is movable from a first location to another location without removing the physical lock.

16. The system of claim 11, wherein the portable device is a portable projector.

17. An information handling system (IHS) comprising:
a processor;
a display controller coupled to the processor via a bus;
a portable projector coupled to the display controller, the portable projector being operable to display an image; and
a security system for securing the portable projector, wherein the security system includes:
a security enabler, wherein the security enabler is configurable to enable the securing of the portable projector;
a physical lock operable to provide a secured coupling between the portable projector and a secured object;
a sensor coupled to the portable projector and being operable to detect the secured coupling; and
a password handler included in the portable projector, the password handler being operable to prompt for a password in response to an absence of the secured coupling, receive the password, and verify the password to enable the portable projector.

18. The system of claim 17, wherein the password handler is bypassed when the secured coupling is detected.

19. The system of claim 17, wherein the portable device is movable from a first location to another location without removing the physical lock.

20. The system of claim 17, wherein the portable projector is disabled in response to a failure to verify the password.
